(19) United States
(12) Patent Application Publication
(10) Pub. No.: US 2009/0027396 A1
(43) Pub. Date: Jan. 29, 2009

(54) METHOD FOR FITTING A PARAMETRIC REPRESENTATION TO A SET OF OBJECTS

(75) Inventor: Sarah F. Frisken, Cambridge, MA (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: TUFTS UNIVERSITY, Boston, MA (US)

(21) Appl. No.: 11/828,430

(22) Filed: Jul. 26, 2007

(51) Int. Cl. G06T 11/20

(52) U.S. Cl. 345/442

(57) ABSTRACT

Described is a method for fitting a parametric representation to digital data. A vector distance field is generated to represent a set of objects and a parametric representation for the set of objects is initialized. A fitting error is determined from the vector distance field representation. The fitting error indicates the accuracy of the fit of the parametric representation to the set of objects. The parametric representation is adjusted and the fitting error is again determined in an iterative manner until an acceptable fitting error is achieved. The method has numerous technical advantages such as robustness, speed, simplicity relative to standard approaches, and the ability to manage constraints such as maintaining corners and enforcing continuity.

### FIELD OF THE INVENTION

The invention relates generally to fitting a parametric representation to a digital representation of an object. More particularly, the invention relates to a method using a vector distance field representation of a set of objects to determine a parametric representation of the set of objects.

### BACKGROUND OF THE INVENTION

Fitting Parametric Surfaces to Digital Data

Digital data such as a set of positions recorded from a digital input device, a set of curves representing a character glyph, or a set of experimental measurements, can be fit with a parametric representation that approximates the shape of the digital data to reduce memory requirements for storing and transmitting the digital data or to facilitate processing of the digital data.

For example, when drawing via a computer mouse or digital pen, the path of the input device is sampled, the sampled points are typically quantized to integer pixel locations, and these digitized points are supplied to an application. While some applications simply represent the input path by the sequence of digitized points, fitting a parametric curve to the digitized points has various advantages such as: 1) a parametric curve generally requires less memory than a list of digitized points; 2) a parametric curve can be scaled, rotated, deformed, etc. without degrading the quality of the path when it is rendered; 3) an application can enforce smoothness and continuity constraints on a parametric curve; and 4) users can generally edit a parametric curve easily.

Although there are many different parametric representations for curves as described by Farin in “Curves and Surfaces for CAGD: A Practical Guide”, Morgan Kaufmann Publishers, Academic Press, 2002, many applications use piecewise polynomial curves such as cubic Bezier curves. A piecewise polynomial curve is composed of multiple polynomial curve segments. When fitting a piecewise polynomial curve to a sequence of digitized points, the goal is to determine an optimal set of curve segments, where optimal can mean some combination of a minimum number of curve segments, a minimum error between the curve segments and the input path, and curve segments that enforce a number of other constraints such as curve continuity or maintaining intended corners of the input path.

Fitting a parametric representation of a medial axis to the center of a set of outlines representing a character glyph is a second example in which digital data is fit with a parametric representation. The medial axis can be used for several applications such as approximating the character glyph to reduce its size or facilitating optical character recognition. For a closed three-dimensional shape, a parametric representation of the medial surface is also of value for shape compression and shape recognition as described by Sheehy et al. in “Shape Description by Medial Surface Construction”, IEEE Transactions On Visualization & Computer Graphics, 1996.

Fitting a parametric surface to a set of digitized points in three-dimensional space, such as a set of points acquired by a range scanning device, is a third example in which digital data is fit with a parametric representation. Various parametric surface representations are used to approximate the scanned surface including a triangle mesh, a set of quadratic, cubic, or higher order Bezier patches, or a set of non-uniform rational B-splines (“NURBs”) patches as described by Farin in “Curves and Surfaces for CAGD: A Practical Guide”, Morgan Kaufmann Publishers, Academic Press, 2002. In one variation, a parametric surface is fit to a regularly sampled volume or an adaptively sampled distance field to generate a parametric representation of an iso-surface of an implicit function. Various methods for constructing triangle meshes from sampled data exist, including Marching Cubes, described in U.S. Pat. No. 4,710,876, and SurfaceNets, described in U.S. Pat. No. 6,943,789.

Fitting an N-dimensional ellipsoid to a set of measured or simulated N-dimensional data to represent a probability distribution of the set of measured or simulated N-dimensional data is a fourth example in which digital data is fit with a parametric representation.

A review of standard approaches for fitting curves and surfaces to a set of digitized points is presented in “Least Squares Orthogonal Distance Fitting of Curves and Surfaces in Space”, S. J. Ahn, Lecture Notes in Computer Science, Springer-Verlag, 2004 (“Ahn”). In the case of piecewise polynomial curves, the curve fitting problem reduces to finding a set of control vertices for the curve segments that minimizes the geometric, or Euclidean, distance between the digitized points and the fit curve. Ahn observes that the geometric distance is a non-linear function of the control vertices and that the task of computing and minimizing the sum of squared geometric distances is complex. Ahn describes the curve fitting problem as essentially a non-linear optimization problem which should be solved using iteration. Given a sequence of digitized points {Pi}, i=1, 2, . . . N, an iterative approach for curve fitting applies the following steps:
1. Start with a simple initial estimating curve, such as a straight line segment connecting the endpoints of the sequence, and an initial set of minimum distance points {Qᵢ}, i=1, 2, . . . N, where each Qᵢ is a point on the estimating curve that is closest to a corresponding digitized point Pᵢ.
2. Iteratively adjust control vertices of curve segments of the estimating curve to reduce the fitting error (i.e., a measure of the accuracy of the fit to the estimating curve), where the fitting error is typically estimated as the sum of squared distances between each {Pᵢ, Qᵢ} pair. For each iteration, the set of minimum distance points {Qᵢ} is re-computed. Typically, the re-computation also requires an iterative approach.
3. If necessary, subdivide the estimating curve into additional curve segments.
4. Repeat steps 2 and 3 until the fitting error is acceptable.

Re-computing the minimum distance points in step 2 is done for each iteration of the control vertex adjustment. Unfortunately, this inner loop is generally the most time consuming part of the algorithm. There are two basic approaches for finding the minimum distance points as described by Ahn. The first approach determines the closest point Qᵢ on the estimating curve for each digitized input point Pᵢ directly using an iterative polynomial root finder. This requires solving a 5th order polynomial for each cubic Bezier curve segment of the estimating curve. The second approach determines a parameter value tᵢ for each digitized point Pᵢ so that Q(tᵢ) is the closest point on the piecewise parametric estimating curve to Pᵢ. When using the second approach, the parameterization of the digitized points is typically initialized using chord length parameterization of the estimating curve and then adjusted iteratively using a polynomial root finder as described by Schneider in “Phoenix: An Interactive Curve Design System Based on the Automatic Fitting of Hand-sketched Curves”, Master's Thesis, University of Washington, 1988, and in “An Algorithm for Automatically Fitting Digitized Curves”, in Graphics Gems, ed. Andrew Glassner, Academic Press, 1990.

Standard approaches for curve and surface fitting suffer from a number of drawbacks. One such drawback is that the standard approaches are designed to operate only on a full sequence of digitized points, such as all of the points recorded along a single input path. Because the fit curve is not determined until the input path has been completed, an approximation of the input path, such as the digitized points themselves or a polyline connecting the digitized points, must be drawn to provide feedback to the user. This can result in a delay after the input path is complete and can result in a noticeable change in the shape of the drawn path when the approximation of the input path is replaced by the fit curve.

A second major drawback is the costly inner loop for determining minimum distance points. The computation involved in the inner loop is proportional to the number of points in the sequence of digitized points. Preprocessing can be used to reduce the number of digitized points as well as to remove noise such as hand jitter from the input data; however, preprocessing is time consuming and can result in a loss of intended detail. Other problems with standard approaches occur because of a lack of robustness in the iterative methods for determining minimum distance points. These methods are sensitive to local minima, particularly for complex, self-intersecting input paths, and require a good initial set of minimum distance points.

Thus, there is a need for an improved method for fitting curves and surfaces to digital data.

Distance Fields

A distance field of a shape measures, for any point in space, the distance from that point to the closest point on the shape. Distance fields have been used for many applications in computer graphics, computer aided design and manufacturing, computer vision, and robotics. A general review of the use of distance fields in computer graphics and vision is described by Frisken and Perry in “Efficient Estimation of 3D Euclidean Distance Fields from 2D Range Images”, in Proc. Symposium on Volume Visualization and Graphics, 2002. A review of the use of distance fields in shape modeling is described by Frisken and Perry in “Designing with Distance Fields”, in Interactive Shape Editing, ACM SIGGRAPH 2006 Course Notes, ACM Press, 2006.

Conventionally, distance fields are scalar fields, for example distance fields which represent the scalar Euclidean distance from any point to a shape. In contrast, vector distance fields represent the distance at any point as a vector value. Vector distance fields are more suitable than scalar distance fields for representing shapes that do not have a well defined inside and outside and for algorithms that require the gradient of the distance field. Although the following description is directed to Euclidean vector distance fields, which have obvious geometric meaning, the principles also apply to non-Euclidean vector distance fields such as vector distance fields whose magnitudes vary as the square of the Euclidean distance.

The two-dimensional vector distance (dx, dy) from any given sample point (x, y) in [symbol] 2 to a closest point (u, v) on a two-dimensional shape is defined to be the two-dimensional vector from the sample point to the closest point, i.e., (dx, dy)=(u−x, v−y). The extension to three-dimensional and higher dimensional vector distances is straightforward. The magnitude of the vector distance, (dx²+dy²)^{1/2}, is the minimum Euclidean distance from the sample point to the shape, and the vector distance itself is equal to the unit gradient vector of the Euclidean distance field at the sample point scaled by the minimum Euclidean distance to the shape.

A vector distance field of an object represents, at any point in space, the vector distance from that point to the object. Vector distance fields were introduced for shape representation as described in U.S. Pat. No. 6,396,492 and for evolving surfaces via level sets as described by Faugeras and Gomes in “Dynamic Shapes of Arbitrary Dimension: The Vector Distance Functions”, Proceedings IMA Conference on Mathematics of Surfaces, pp. 227-262, 2000. Vector distance fields are particularly well suited for representing shapes that do not have a well defined inside and outside (e.g., points, lines, curves, and infinitely thin surfaces) because each component (e.g., dx, dy) of the vector distance varies smoothly (i.e., from negative to positive) from one side of the shape to the other. In contrast, scalar distance fields of such shapes are non-differentiable at points on the shape so that, for example, it is not possible to use linear interpolation to locate points on the shape, where the scalar distance is zero, from sample points that span the shape since sampled values on opposite sides have the same sign.

Vector distance fields are also well suited for applications that require the gradient of the distance field since the gradient can be interpolated directly and more accurately from sampled vector distances using bilinear interpolation rather than indirectly from sampled Euclidean distances using a higher order and less accurate gradient operator such as the central differences operator.

There are various representations of vector distance fields. Vector distance fields can be represented by analytic functions, for example, the three-dimensional vector distance at a sample point (x, y, z) to a point (u, v, w) is (u−x, v−y, w−z), or by procedures. Vector distance fields can be sampled and stored in a regularly sampled two-dimensional array, referred to as a vector distance map. Vector distances between sample points in a vector distance map can be reconstructed using bilinear interpolation of each component of the vector distance. Vector distance fields can also be adaptively sampled and represented as an adaptively sampled distance field, as described in U.S. Pat. No. 6,396,492.

### SUMMARY OF THE INVENTION

In one aspect, the invention features a method for fitting a parametric representation to a set of objects. A vector field representation of the set of objects is generated and a parametric representation to fit the set of objects is initialized. A fitting error indicating an accuracy of the fit of the parametric representation to the set of objects is determined from the vector distance field representation. The parametric representation is adjusted to reduce the fitting error.

In another aspect, the invention features a computer program product for fitting a parametric representation to a set of objects. The computer program product includes a computer useable medium having embodied therein program code. The program code includes program code for generating a vector distance field representation of the set of objects and program code for determining a fitting error from the vector distance field representation. The fitting error indicates an accuracy of the fit of the parametric representation to the set of objects. Also included is program code for adjusting the parametric representation to reduce the fitting error.

In still another aspect, the invention features an apparatus for fitting a parametric representation to a set of objects. The apparatus includes means for generating a vector distance field representation of the set of objects, means for initializing a parametric representation to fit the set of objects and means for determining a fitting error from the vector distance field representation. The fitting error indicates an accuracy of the fit of the parametric representation to the set of objects. The apparatus also includes means for adjusting the parametric representation to reduce the fitting error.

### BRIEF DESCRIPTION OF THE DRAWINGS

FIG. 1 is a diagram of a two-dimensional vector distance from a point to a two-dimensional curve;

FIG. 2 is a flow diagram of a method for fitting a parametric representation to a digital representation of an object according to the present invention;

FIGS. 3A, and 3B are diagrams depicting the fitting of a parametric curve to a set of digital points according to standard methods;

FIGS. 4A, 4B, and 4C are diagrams depicting the fitting of a parametric curve to a set of digital points according to the present invention;

FIG. 5 is a flow diagram of a method for fitting a parametric representation to a sequence of digitized points according to the present invention;

FIG. 6 is a diagram depicting the constraint of a parameter of a parametric representation according to the present invention;

FIGS. 7A, 7B, 7C, and 7D are depictions of the fitting of a parametric surface to a three-dimensional set of digital points according to the present invention;

FIGS. 8A, 8B, 8C, and 8D are diagrams depicting the fitting of a medial axis to a closed outline of a character glyph according to the present invention; and

FIG. 9 is a flow diagram of a method for recognizing a shape from a set of digitized points according to the present invention.

### DETAILED DESCRIPTION

The invention relates to the fitting of a parametric representation to a digital representation of an object. Some examples of digital representations for the object are: a set of digitized points; a set of line segments or curve segments; a set of surface patches such as triangle patches, quadrilateral patches, Bezier patches, or NURBs patches; an implicit function; an analytic function; or a set of sampled data such as a two dimensional image, a three-dimensional sampled volume, or an adaptively sampled distance field.

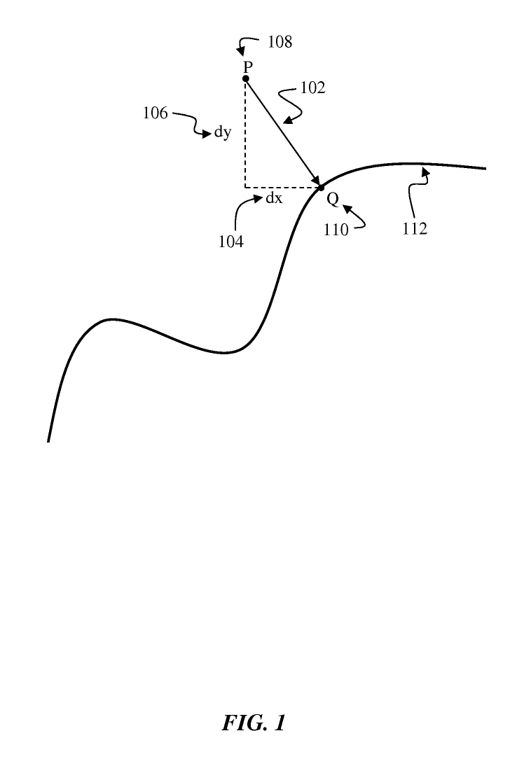

The method of the invention uses a vector distance field representation of the object. FIG. 1 illustrates a two-dimensional vector distance 102 from a point P 108 in two-dimensional space to a closest point Q 110 on a two-dimensional curve 112. The vector distance 102 is composed of components dx 104 and dy 106.

General Description

Fitting a parametric representation to a digital representation of an object, such as a set of digitized points along an input path of a digitizing input device, is typically posed as a non-linear optimization problem which is usually solved using an iterative approach. In such an iterative approach, a simple parametric representation is initialized to approximate the object, a fitting error (i.e., a measure of the accuracy of the fit) between the parametric representation and the object is determined, and parameters of the parametric representation are iteratively adjusted to reduce the fitting error.

In standard approaches, the fitting error is a function of distances from sample points on the object, such as a set of digitized points along an input path, to the parametric representation. These approaches require finding the closest point on the parametric representation for each sample point on the object. Finding each closest point is an expensive operation that is performed for every sample point on the object each time the parameters are adjusted.

According to the invention, a vector distance field representation of the object is generated and a fitting error that represents the distance from a set of test points on the parametric representation to the object is determined. The distance at each test point is determined using the vector distance field representation.

A common measurement of the fitting error is a sum of squared distances between the estimating curve and the input path at a set of test points. There are alternative measurements of the fitting error such as a sum of unsigned scalar distances between the estimating curve and the input path at a set of test points, or a function of signed scalar distances between the estimating curve and the input path at a set of test points.

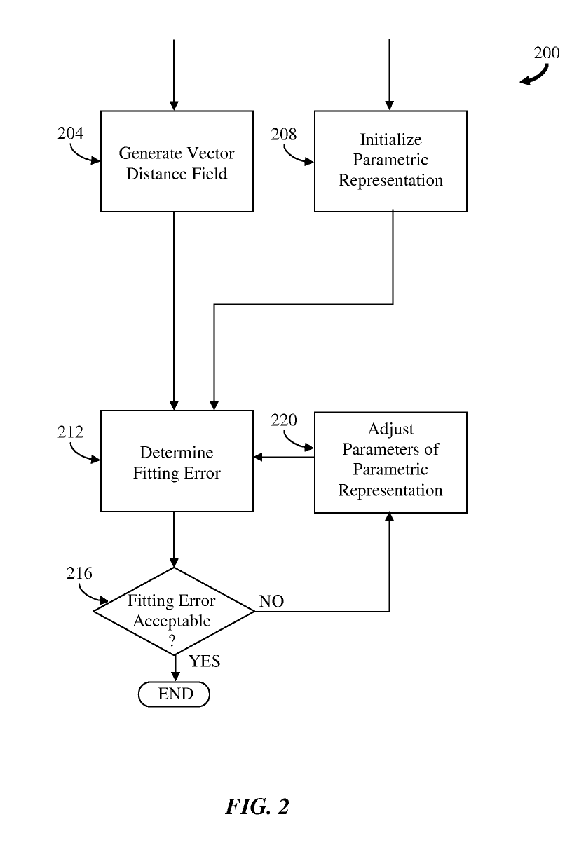

FIG. 2 is a flow diagram of a method 200 for fitting a parametric representation to an object according to an embodiment of the invention. A vector distance field is generated 204 and a parametric representation to be fit to the object is initialized 208. A fitting error is determined 212 from the vector distance field and the parametric representation. If it is determined 216 that the fitting error is acceptable then the method 200 ends, otherwise the parameters of the parametric representation are adjusted 220 and the fitting error is examined 212 in an iterative manner until it is determined 216 that the fitting error is acceptable. An acceptable fitting error can occur when the value is less than a predetermined value.

The particular parametric representation used may depend on the object to be fit. For example, a two-dimensional parametric curve such as a two-dimensional cubic Bezier curve, whose parameters comprise its four control vertices, can be fit to a set of digitized points acquired along a path of a digitizing device such as a computer mouse or a digital pen.

As a second example, a parametric surface patch such as a NURBs surface patch, whose parameters comprise a set of control vertices, can be fit to a set of three-dimensional points acquired with a range scanning device.

As a third example, a two-dimensional ellipse, whose parameters comprise a center point, an orientation, a major radius and a minor radius, can be fit to a set of two-dimensional sampled data points to represent a level set of a bivariate probability density function modeling the data points.

As a fourth example, a set of two-dimensional parametric curves can be fit to a medial axis of a closed two dimensional outline.

As a fifth example, a piecewise polynomial Bezier surface can be fit to an iso-surface of an adaptively sampled distance field.

There are other examples of parametric representations such as: line segments, curves, circles, and rectangles for representing one-dimensional manifolds; triangles, filled ellipses, polygons, and curved patches for representing two-dimensional manifolds; spheres, ellipsoids, super ellipsoids and rectangular solids for representing three-dimensional manifolds; and n-dimensional solids for representing n-dimensional manifolds.

Sketching with a Digitizing Device

In a first embodiment, a piecewise polynomial estimating curve composed of two-dimensional cubic Bezier curve segments is fit to a sequence of digitized points representing a path of a digitizing device on-the-fly, i.e., as each digitized point is provided to the application. In this embodiment, the digitized points are recorded using a two-dimensional input device such as a computer mouse or a digital pen, or a three-dimensional input device such as a force feedback device or a three-dimensional tracking device.

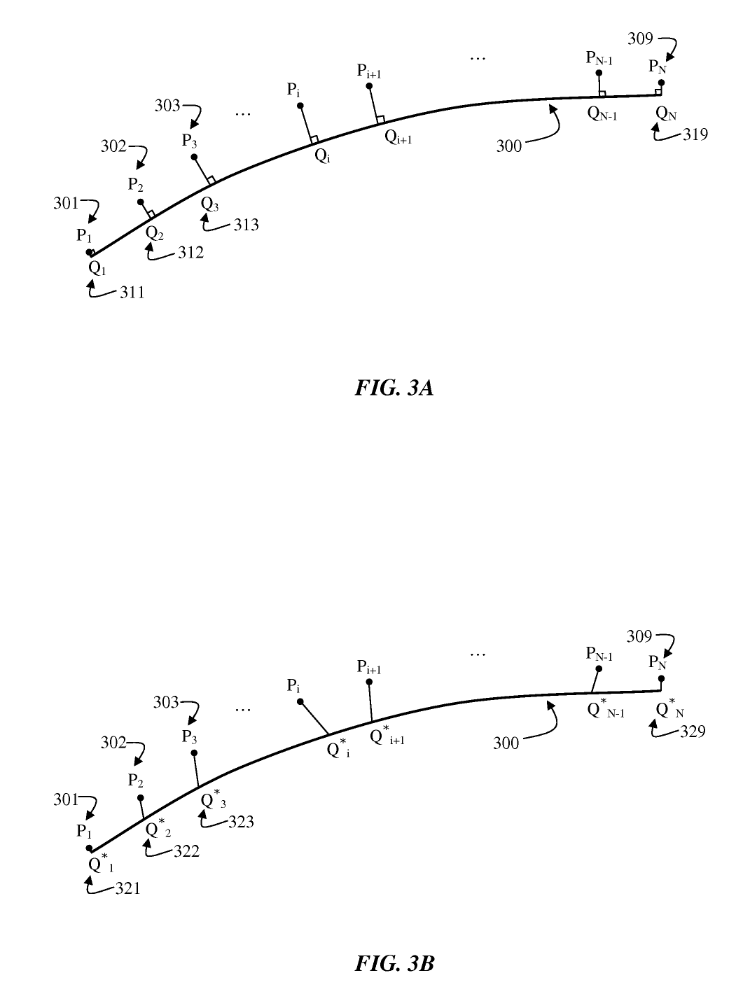

Standard curve fitting approaches measure a distance from each digitized point to the estimating curve, which requires finding a closest point on the estimating curve for each digitized point each time parameters of the estimating curve are adjusted. FIG. 3A illustrates the closest points Qᵢ 311, 312, . . . , 319 (generally Q) on the estimating curve 300 corresponding to each sample point Pᵢ 301, 302, . . . , 309 (generally P) of the object. As illustrated in FIG. 3B, the closest points Q are typically determined using an iterative approach. Such approaches iteratively adjust a set of initial estimates Q*ᵢ 321, 322, . . . , 329 until they are approximately located at the closest points Q.

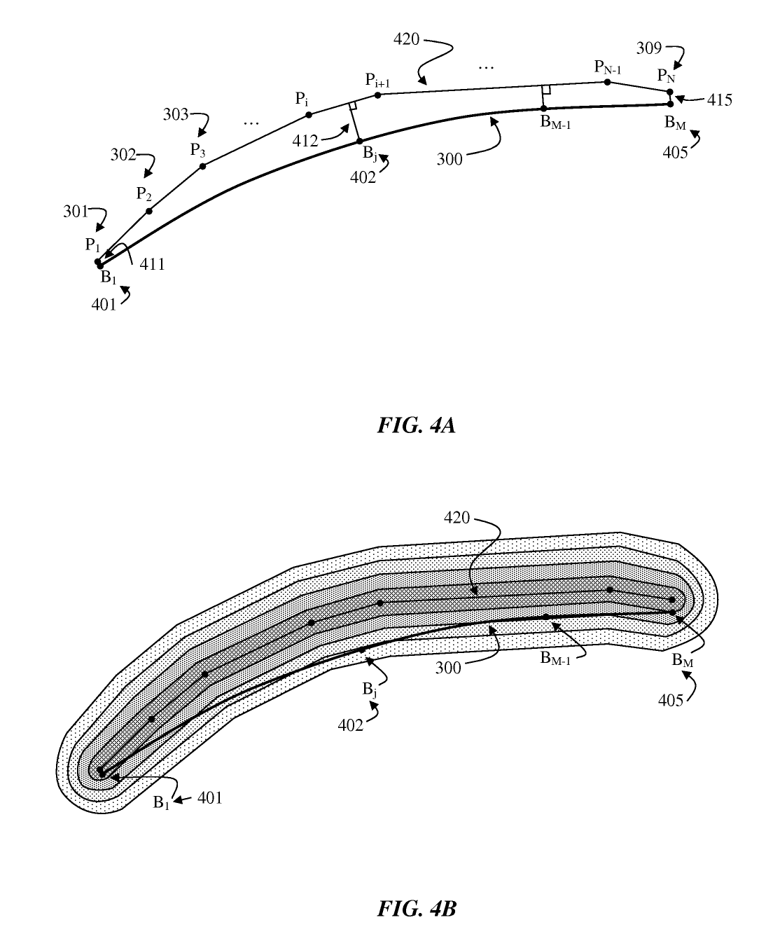

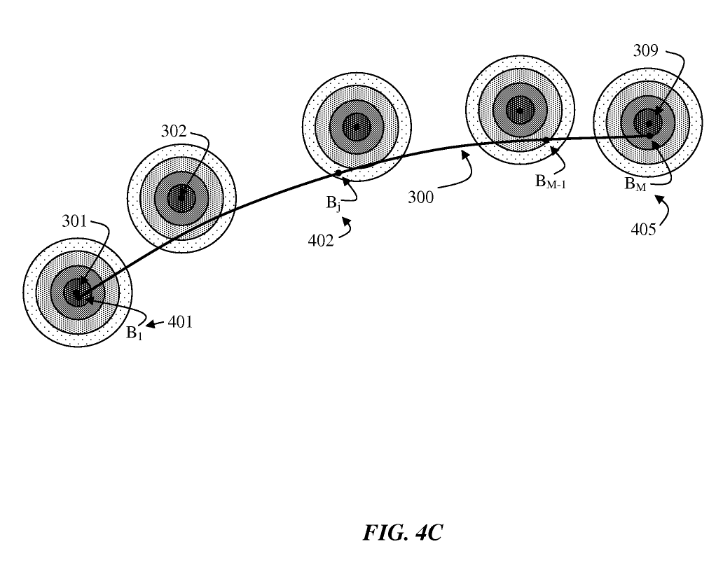

To fit a parametric representation to an object according to the invention, the distances from a set of test points on the estimating curve to an approximation of the input path are determined. FIG. 4A illustrates a set of test points Bⱼ 401, 402, . . . , 405 on the estimating curve 300 and their corresponding vector distances 411, 412, . . . , 415 to a polyline 420 which approximates the input path. Various approximations of the input path are possible, such as the sequence of digitized points P or the polyline 420 connecting the sequence of digitized points P. FIG. 4B illustrates iso-contours of the magnitude of the vector distance field of the polyline 420. FIG. 4C illustrates iso-contours of the magnitude of the vector distance field of the sequence of digitized points P. The input path is approximated with a set of polylines where each polyline connects a subsequence of the sequence of digitized points P, the subsequences partitioning the sequence of digitized points P at corner points in the input path.

This paradigm shift increases the efficiency of curve fitting for several reasons such as: 1) each polyline is represented as a sampled vector distance field so the distance from test points to the polyline can be computed directly and efficiently using linear interpolation of sampled vector distances in the sampled vector distance field; 2) the polyline's vector distance field changes only incrementally as each new digitized point is added to the polyline and does not change each time parameters of the estimating curve are adjusted; and 3) the number of test points along the estimating curve can be significantly smaller than the number of digitized points without compromising quality, thereby avoiding the need for preprocessing to reduce the number of digitized points. The increase in efficiency allows the curve to be fit to the input path incrementally, thereby providing a means for updating the estimating curve as new digitized points become available.

The estimating curve is constrained to have G¹ continuity to ensure that the fit curve is a smooth approximation to the input path. In addition, an acceptable non-zero curve fit error (e.g., an error of 1-2 pixels) is predefined so that the estimating curve is not required to be exactly fit to the polyline.

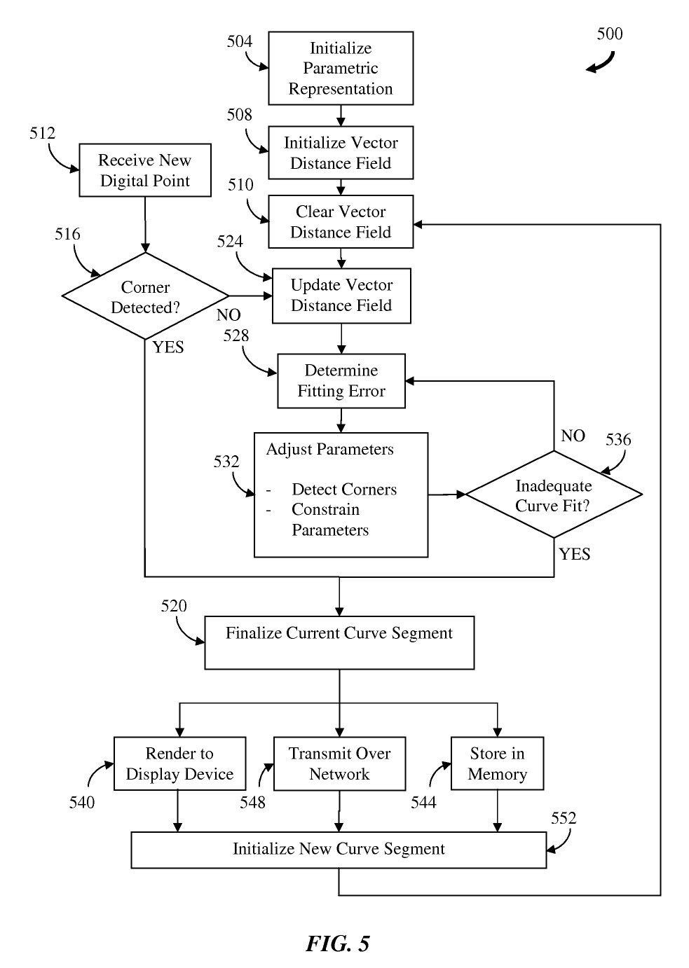

The first embodiment applies the following steps, illustrated in FIG. 5, for fitting a piecewise polynomial curve to a sequence of digitized points as each digitized point is acquired:
1. Initialize 504 a first two-dimensional cubic Bezier curve segment of the piecewise polynomial estimating curve by setting its control vertices to a first digitized point in the sequence of digitized points.
2. Initialize 508 and clear 510 a two-dimensional vector distance field for representing a polyline corresponding to a current curve segment.
3. Repeat, the following sub-steps as each new digitized point is received 512 from the digitizing device:
   i. Test 516 for a corner between the current curve segment's last endpoint and the new digitized point by comparing a path angle to a maximum corner angle, where the path angle is an angle from the current curve segment's tangent vector at the current curve segment's last endpoint and a line segment from the current curve segment's last endpoint to the new digitized point. If a corner exists, finalize 520 the current curve segment, initialize 552a new curve segment in the estimating curve and clear 510 the two-dimensional vector distance field representation. Require only C⁰ continuity at the new curve segment's first endpoint to maintain a corner point at the new curve segment's first endpoint.
   ii. If no corner is determined 516 to exist, update 524 the vector distance field representation with the new digitized point.
   iii. Adjust 532 control vertices of the current curve segment to reduce a fitting error of the estimating curve, which is determined 528 using vector distances from test points on the estimating curve to the polyline. Enforce G¹ continuity with the previous curve segment if required.
   iv. Test 536 for an inadequate curve fit. If, after adjusting 532 the current curve segment's control vertices, the fitting error of the estimating curve exceeds a maximum fitting error, undo the control vertex adjustments, finalize 520 the current curve segment, initialize 532 a new curve segment in the estimating curve and clear the vector distance field representation 510. Require G¹ continuity at the new curve segment's first endpoint.
   v. Prior to initializing 532 each new curve segment, the method 500 can re-render 540 to a display, store 544 in memory, or transmit over a network 548, the piecewise polynomial estimating curve.

The fitting error, E, of each curve segment in the estimating curve is approximated as an average squared scalar distance from a set of test points {Qᵢ=B(tᵢ)} on the curve segment to the polyline connecting the subsequence of digitized points corresponding to the current curve segment:

$$E = \frac{1}{N} {\sum }_{i = 1}^{N} {d ( {Q}_{i} )}^{2} ,$$

where d(Q) is the scalar distance from Q to the polyline.

In the first embodiment, endpoints of each curve segment in the estimating curve are constrained to lie on a digitized point and an iterative algorithm is used to reduce the fitting error of the curve segment by adjusting its off-curve control vertices. A point B(t) on a cubic Bezier curve with endpoints C₀ and C₃ and off-curve control vertices C₁ and C₂ can be expressed as a cubic polynomial of a parameter tε[0, 1]:

B(t)=C₀(1−t)³+3C₁t(1−t)²+C₂t³(1−t)+C₃t³.

During each iteration, off-curve control vertices are moved according to an adjustment force in a direction that reduces the curve fitting error, such as the direction of the derivative of the error with respect to the position of the off-curve control vertex. Taking this derivative for the first off-curve control vertex and using the chain rule, the adjustment “force” \vec{f}₁ acting on off curve control vertex C₁ is:

$$\begin{matrix}{\vec{f}}_{1} = {∇}_{{C}_{1}} E \\ = \frac{1}{N} {\sum }_{i = 1}^{N} 2 d ( {Q}_{i} ) \cdot {∇}_{{C}_{1}} d ( {Q}_{i} ) \\ = \frac{1}{N} {\sum }_{i = 1}^{N} 2 d ( B ( {t}_{i} ) ) \cdot {∇}_{{C}_{1}} d ( B ( {t}_{i} ) ) .\end{matrix}$$

Note that

$$\begin{matrix}{∇}_{{C}_{1}} d ( B ( {t}_{i} ) ) = ( \frac{\partial d ( B ( {t}_{i} ) )}{\partial {x}_{1}} , \frac{\partial d ( B ( {t}_{i} ) )}{\partial {y}_{1}} ) for {C}_{1} \\ = ( {x}_{1} , {y}_{1} ) \\ = ( \frac{\partial d ( x ( {t}_{i} ) )}{\partial x ( {t}_{i} )} \cdot \frac{\partial x ( {t}_{i} )}{\partial {x}_{1}} , \frac{\partial d ( y ( {t}_{i} ) )}{\partial y ( {t}_{i} )} \cdot \frac{\partial y ( {t}_{i} )}{\partial {y}_{1}} ) for B ( {t}_{i} ) \\ = ( x ( {t}_{i} ) , y ( {t}_{i} ) ) ,\end{matrix}$$

using the chain rule.

### Consequently,

$$\begin{matrix}{∇}_{{C}_{1}} d ( B ( {t}_{i} ) ) = 3 {t}_{i} \cdot {( 1 - {t}_{i} )}^{2} \cdot ( \frac{\partial d ( x ( {t}_{i} ) )}{\partial x ( {t}_{i} )} , \frac{\partial d ( y ( {t}_{i} ) )}{\partial y ( {t}_{i} )} ) \\ = 3 {t}_{i} \cdot {( 1 - {t}_{i} )}^{2} \cdot ∇ d ( B ( {t}_{i} ) ) .\end{matrix}$$

$$Thus , \\ \begin{matrix}{\vec{f}}_{1} = \frac{1}{N} {\sum }_{i = 1}^{N} 2 d ( B ( {t}_{i} ) ) \cdot 3 {t}_{i} \cdot {( 1 - {t}_{i} )}^{2} \cdot ∇ d ( B ( {t}_{i} ) ) \\ = \frac{6}{N} {\sum }_{i = 1}^{N} {t}_{i} \cdot {( 1 - {t}_{i} )}^{2} \cdot d ( B ( {t}_{i} ) ) \cdot ∇ d ( B ( {t}_{i} ) ) .\end{matrix}$$

Similarly, the adjustment “force” \vec{f}₂ acting on off curve control vertex C₂ is

$$\begin{matrix}{\vec{f}}_{2} = {∇}_{{C}_{2}} E \\ = \frac{1}{N} {\sum }_{i = 1}^{N} 2 d ( {Q}_{i} ) \cdot {∇}_{{C}_{2}} d ( {Q}_{i} ) \\ = \frac{6}{N} {\sum }_{i = 1}^{N} {t}_{i}^{2} \cdot ( 1 - {t}_{i} ) \cdot d ( B ( {t}_{i} ) ) \cdot ∇ d ( B ( {t}_{i} ) ) .\end{matrix}$$

To reduce the fitting error, the positions of the off-curve control vertices C₁ and C₂ are iteratively adjusted by adding to them, the adjustment forces \vec{f}₁ and \vec{f}₂, respectively, scaled by a proportionality constant α:

C₁^{j+1}=C₁^{j}+α\vec{f}₁

C₂^{j+1}=C₂^{j}+α\vec{f}₂

In general, the proportionality constant αε [0,1] determines stability and convergence properties of the curve fitting, with a smaller α providing more stability but slower convergence. However, because components of the vector distance field are nearly linear close to the polyline, the method according to the first embodiment is reasonably insensitive to α so that an α value of 1 provides fast convergence and good stability.

Both \vec{f}₁ and \vec{f}₂ are functions of the scalar distance to the polyline d(Q) and the gradient of the scalar distance field Δd(Q) at the set of test points {Qᵢ=P(tᵢ)} on the curve segment. In particular, d(Q)·Δd(Q)=∥(dx, dy)∥·(dx, dy), where (dx, dy) is the vector distance at point Q. Thus, the adjustments \vec{f}₁ and \vec{f}₂ can be computed directly by interpolating the vector distance map of the polyline at the test points {Qᵢ}.

Maintaining G¹ Continuity of the Estimating Curve

The smoothness of an analytic curve can be described in terms of its continuity, which is a function of its differentiability at points along the curve. Because polynomial curves are everywhere infinitely differentiable, the continuity of a piecewise polynomial curve is determined by the continuity at the joints between curve segments: C⁰ continuity simply implies that curve segments are connected at their endpoints; C¹ continuity implies that the tangent vectors of connected curve segments are parallel and have equal length at the point where they are joined; C² continuity implies that the curvature of connected curve segments is equal at the point where they are joined, and so on.

Geometric continuity, G^{N}, is somewhat less restrictive than algebraic continuity, C^{N}. In particular, two curve segments are G¹ continuous if their tangent vectors are parallel but not necessarily equal in length at the point where they are joined. Note that G¹ continuous curve segments are smooth enough for most applications but the first embodiment can be extended to achieve higher order algebraic or geometric continuity when higher order Bezier curves are used in the piecewise polynomial curve.

The tangent vector of a cubic Bezier curve is \vec{t}(t)=(dB(t)/dx, dB(t)/dy)=3(C₁−C₀)(1−t)²+6(C₂−C₁)t(1−t)+3(C₃−C₂) t². At the curve's first and last endpoints, \vec{t}(0)=3(C₁−C₀) and \vec{t}(1)=3(C₂−C₃), respectively. These endpoint tangent vectors lie on the lines connecting the first endpoint to the first off-curve control vertex and the second endpoint to the second off-curve control vertex, respectively. Hence, to maintain G¹ continuity at non-corner points between a new curve segment and its preceding curve segment, the first off-curve control vertex of the new curve segment is constrained to lie on a line passing through the preceding curve segment's second endpoint and its second off-curve control vertex.

The first off-curve control vertex of the new curve segment originates on the line because it is initialized to lie at the endpoint common to the new curve segment and the preceding curve segment. Thus, the first off-curve control point can be constrained to lie on the line by restricting the displacement \vec{f}₁ of the first control vertex to be parallel to the line. Thus, to maintain G¹ continuity at the first endpoint of the new curve segment, \vec{f}₁ is replaced with the constrained displacement \vec{f}₁*=(\vec{f}₁∘\vec{l})·\vec{l}, where \vec{l} is the unit direction vector of the line and ‘∘’ is the vector dot product, and the first off-curve control vertex of the new curve segment is adjusted using C₁^{j+1}=C₁^{j}+α\vec{f}₁*.

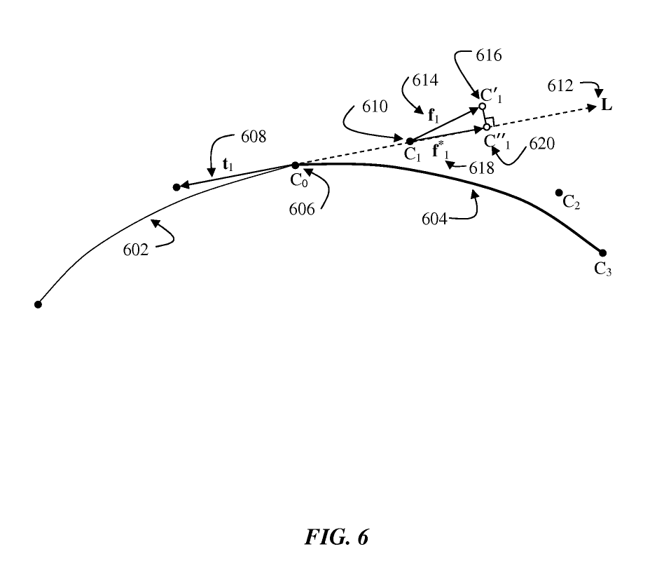

FIG. 6 illustrates a method for constraining the first off-curve control vertex. Two curves 602 and 604 are joined at a point 606, which is the last control vertex of curve 602 and the first control vertex C₀ of curve 604. Curve 602 has tangent vector t₁ 608 at the point 606. To maintain G¹ continuity at the point 606, the first off-curve control vertex C₁ 610 of curve 604 is constrained to lie on the line L 612 which is collinear with the tangent vector 608. Hence the determined displacement \vec{f}₁ 614 for reducing the fitting error, which would move the first control vertex 608 off of the line 612 to a new position C′₁ 616, is modified to the constrained displacement \vec{f}₁* 618 parallel to the line 612. The constrained displacement 618 moves the control vertex 610 to a new position C″₁ 620 which lies on the line 612, thereby maintaining G¹ continuity.

The constrained adjustment of control vertex C₁ 610 can be applied in a number of different ways. One way is to use the constrained displacement \vec{f}₁* 618 to adjust C₁ 610 as described above. A second way is to use the un-constrained displacement \vec{f}₁ 614 to adjust C₁ 610 to C′₁ 616 and then to project onto L 612.

Efficient Incremental Computation of the Vector Distance Field

Computing the control vertex adjustments required for on-the-fly curve fitting described above uses vector distances from test points along the estimating curve to the input path. These vector distances can be computed using a brute force approach that first computes vector distances from each test point to every line segment in the polyline representing the input path and then chooses the vector distance with the minimum magnitude. The brute force approach can be improved using geometric data structures to reduce the number of distances computed and compared for each test point.

In the first embodiment, the polyline is represented by a vector distance map that is incrementally updated as each new digitized point is acquired. Vector distances at test points can then be efficiently interpolated from sampled distances in the vector distance map, for example, by using bilinear interpolation. Achieving on-the-fly curve fitting during drawing requires an efficient method for computing the vector distance map.

In the first embodiment, the vector distance map is stored in a two-dimensional image with the same dimensions and resolution as the display window used by the drawing application. Two 32-bit floating point values are stored per pixel, one value for dx and one value for dy. Alternatively, two 8-bit values can be used to reduce memory requirements without compromising accuracy. If required, using an adaptively sampled vector distance field representation can provide additional compression and/or reduce processing loads.

The vector distance field of the polyline is a CSG union of the vector distance fields of the polyline's individual line segments, where the CSG union of two vector distances chooses the vector distance with the smaller magnitude. Thus the vector distance map of the polyline can be constructed incrementally; when a new digitized point becomes available, the vector distance field of the line segment from the end of the existing polyline to the new digitized point is simply added to the existing vector distance map using a CSG union operation.

The vector distance field of a line segment is composed of the field closest to the line segment and the field closest to the digitized points defining its endpoints. In practice the vector distance field of only one of the two endpoints is computed for each line segment because endpoints are shared along the polyline. Computing the vector distance field for each line segment can be made very efficient for the following two reasons.

First, the estimating curve is not far from the polyline. Hence, the vector distance field is only required within a limited radius, R, from the polyline, where R is determined by the maximum allowable curve error and the spacing between input points. Consequently, a limited region enclosing each line segment is defined within which the vector distance field is computed. Because contributions from each line segment are added using the CSG union operator, the limited regions can overlap, allowing the use of regions with simple geometry. Quadrilateral regions are chosen—for an endpoint, an axis-aligned square centered on the endpoint with sides of length 2R is used and, for a line segment, a rectangle centered along the line segment with width 2R is used.

Second, the x and y components of the vector distance fields of points and lines are linear. Thus, to add the vector distance field of a new line segment to the existing vector distance field, two simple geometric shapes are rasterized: a square limiting the vector distance field of the line segment's first endpoint and a rectangle limiting the vector distance field of the line segment. During rasterization, the x and y components of the vector distance fields are computed at corners of their respective quadrilateral regions and linearly interpolated across the quadrilateral regions. The CSG union operator compares the magnitude of the interpolated vector distance at a particular raster location to the magnitude of the corresponding vector distance already stored in the vector distance map and chooses the vector distance with the smaller magnitude.

Fitting a Surface to a Set of Surface Points

A second embodiment of the method of the invention fits a parametric surface representation to a set of digitized points. A first step of the second embodiment is to generate a vector distance field representation of the set of digitized points. There are various approaches for generating the vector distance field. In the second embodiment, the vector distance field is sampled and stored in a regularly sampled volume. Alternatively, the vector distance field can be sampled adaptively and represented as an adaptively sampled distance field. In another alternative, the vector distance field is represented analytically, for example as the CSG union of the vector distances to each point in the set of digitized points. In yet another alternative, the vector distance field is represented procedurally, for example as a procedure that first finds a set of closest digitized points from a spatial data structure and then determines the vector distance from the set of closest digitized points.

The vector distance field can also be derived from a scalar distance field by scaling the gradient of the scalar distance field at any point by its scalar distance, the absolute value of its scalar distance, the square of its scalar distance, or a function of its scalar distance. The gradient of the scalar distance field can be determined analytically or procedurally depending on the representation of the scalar distance field. For example, a common approach for estimating the gradient of a regularly sampled scalar distance field is to use the central differences operator, which is known in computer graphics and image processing.

The vector distance field can be generated directly from the set of digitized points, for example by combining the vector distance fields of all of the digitized points using a CSG operation that chooses a vector distance from a set of vector distances with the smallest magnitude, or a blending function that computes a weighted sum or average of a set of vector distances. Alternatively, the vector distance field can be generated from an intermediate representation in a manner similar to that used to represent the polyline approximation of the input path of a digitizing device in the first embodiment described above. For example, the set of digitized points can be triangulated using Delaney triangulation and then vector distances are computed from sample points to the triangulated surface.

A second step of the second embodiment is to initialize a parametric surface representation to approximate the set of digitized points. There are various approaches for initializing the parametric surface. For example, a user can construct an initial parametric surface composed of a set of coarse surface patches using a drawing application or computer aided design system. As a second example, the parametric surface can be automatically initialized as a minimal bounding sphere surrounding the digitized points. As a third example, the parametric surface can be initialized to be a coarse triangular mesh that is generated either automatically or semi-automatically to approximate the surface.

A third step of the second embodiment is to iteratively adjust parameters of the parametric surface, where the adjustment is responsive to a fitting error between the parametric surface and the set of digitized points using the vector distance field. Parameters of the parametric surface are adjusted to reduce the fitting error, for example, by changing a parameter in a direction that reduces the fitting error the most according to the partial derivative of the fitting error with respect to the parameter.

The parameter adjustment can be constrained to improve the quality of the parametric surface or to improve the fitting process. For example, parameter adjustment can be constrained to reduce surface curvature, thereby favoring a smoother surface. As a second example, when the vector distance field is generated by combining the vector distance fields of all of the digitized points, parameter adjustment can be constrained so that forces acting on the surface are always perpendicular to the surface, for example, by taking the dot product of the vector distance at a test point with the surface normal vector when determining the fitting error.

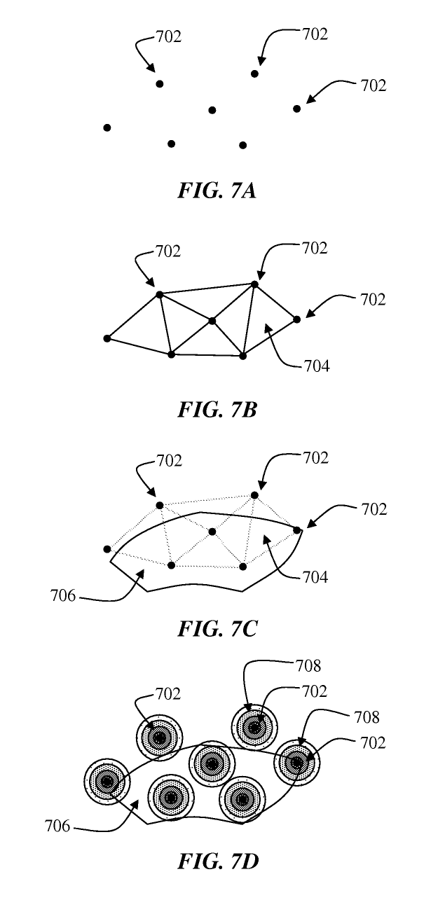

FIGS. 7A-7D illustrate fitting a parametric surface to a set of three-dimensional points. In FIG. 7A, a set of digitized points 702 are provided by the application. A vector distance field can be generated to represent the set of digitized points 702 by first determining a set of triangles 704 that connect the digitized points 702 as illustrated in FIG. 7B and then computing vector distances to the set of triangles 704. Parameters of an initial parametric surface 706 as shown in FIG. 7C can then be adjusted to fit the parametric surface to the set of digitized points using the vector distance field. Alternatively, the vector distance field can be generated by combining vector distances 708 shown in FIG. 7D to the set of digitized points 702 and constraining adjustments to the parametric surface to reduce surface curvature or to move the parametric surface in a direction of the surface normal vector at each test point.

Surfacing a Sampled Distance Field

A third embodiment of the method of the invention fits a surface mesh composed of parametric surface elements to an iso-surface of a regularly sampled distance field. A variation of the third embodiment fits a surface composed of parametric surface elements to an iso-surface of an adaptively sampled distance field. A first step of the third embodiment is to generate a sampled vector distance field. There are various approaches for generating the sampled vector distance field. For example, the sampled vector distance field can be generated directly from a geometric representation of a set of objects or it can be generated from a sampled scalar distance field by computing the gradient of the scalar distance field at sample points in the sampled vector distance field.

In a second step, a surface mesh composed of parametric surface elements is initialized. In this embodiment, a modification of the SurfaceNets algorithm described in U.S. Pat. No. 6,943,789 is used to initialize a surface mesh made up of quadrilateral elements for a regularly sampled vector distance field and triangular and quadrilateral elements for an adaptively sampled vector distance field. Examples of such elements include triangular and quadrilateral cubic Bezier patches or NURBs patches. To initialize the surface mesh, a vertex of the surface mesh is placed at the center of cells of the sampled vector distance field that contain an iso-surface of the vector distance field, that is, in cells with corners on different sides of the iso-surface. Triangular and quadrilateral elements of the surface mesh are then constructed to connect the vertices of each set of cells that share a common edge intersecting the iso-surface.

In a third step, parameters of the mesh surface elements are iteratively adjusted to better fit the surface to the iso-surface of the sampled distance field. This step computes a fitting error from the sampled vector distance field at a set of test points on the mesh surface and adjusts parameters of the mesh surface elements to reduce the fitting error. The adjustments can be constrained to control the curvature of the mesh surface or to control continuity along and across edges of the mesh surface elements.

Determining a Medial Axis of a Closed Outline

A fourth embodiment of the method of the invention determines a medial axis of a two-dimensional closed outline, where the medial axis is composed of a set of piecewise polynomial segments.

In a first step, a two-dimensional adaptively sampled vector distance field of the closed outline is generated, where the adaptive sampling rate is higher near the medial axis of the closed outline. In a second step, cells of the adaptively sampled vector distance field that are inside the closed outline and that contain the medial axis are determined. There are various ways to determine cells that contain the medial axis from the vector distance field. For example, the directions of vector distances at the corner vertices of a cell containing the medial axis are substantially different. Alternatively, the divergence of the vector distance field within a cell containing the medial axis is substantially greater than zero. The divergence of the vector distance field can be determined from the partial derivatives of the vector distance field over the faces of the cell. Alternatively, an interpolated vector distance field within a cell that is defined by bilinearly interpolating the sampled vector distances at the corners of a medial axis cell has a minimum magnitude at a point or a locus of points in the cell.

In a third step, a piecewise polynomial curve is initialized to represent the medial axis. Various initializations are possible, such as a polyline connecting the centers of cells containing the medial axis or a polyline connecting points on the medial axis on the edges of cells containing the medial axis.

In a fourth step, parameters of the piecewise polynomial curve are iteratively adjusted to reduce a fitting error. Just as there are various ways for determining cells that contain the medial axis, there are various ways to determine the fitting error. For example, the fitting error can be determined by comparing samples of the vector distance field on either side of the parametric representation of the medial axis or from samples of partial derivatives of the vector distance field near the parametric representation of the medial axis.

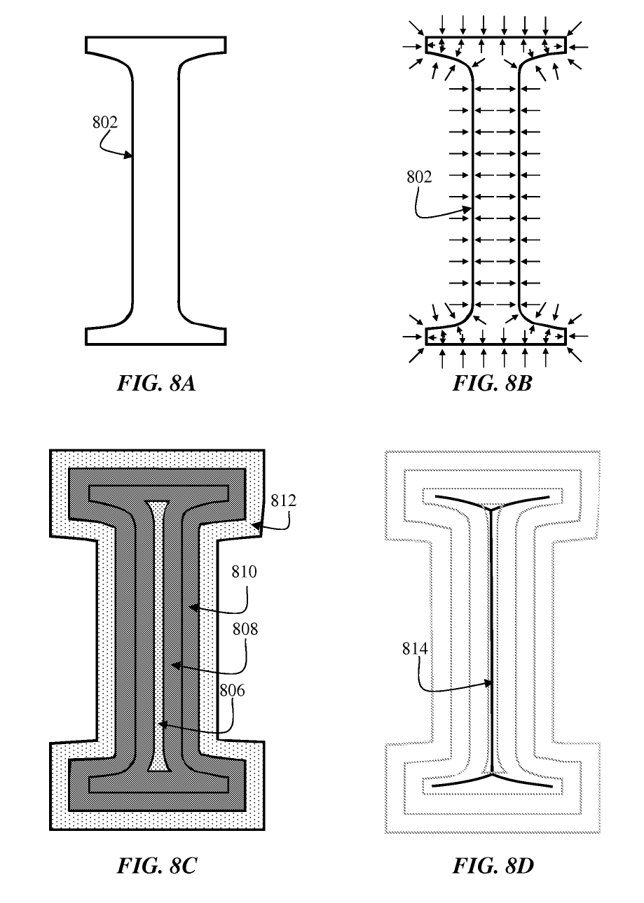

FIG. 8 is illustrates the fitting of a piecewise parametric curve to the medial axis of a closed outline 802 of a glyph ‘I’. FIG. 8A shows the closed outline 802. FIG. 8B shows vector distances (depicted as small arrows) from various sample points in two-dimensional space to the closed outline 802. FIG. 8C shows various iso-contours 806, 808, 810, 812 of the magnitude of the vector distance field of the closed outline 802. FIG. 8D shows the medial axis 814 of the closed outline 802.

Recognizing Stroked Characters

A fifth embodiment of the method of the invention fits a parametric representation to a set of digitized points sampled along a path of a digitizing device where the path of the digitizing device approximates an intended shape, such as a character glyph, a signature, a symbol, or a pattern, and then compares the parametric representation to the parametric representations of a set of known shapes to recognize the intended shape.

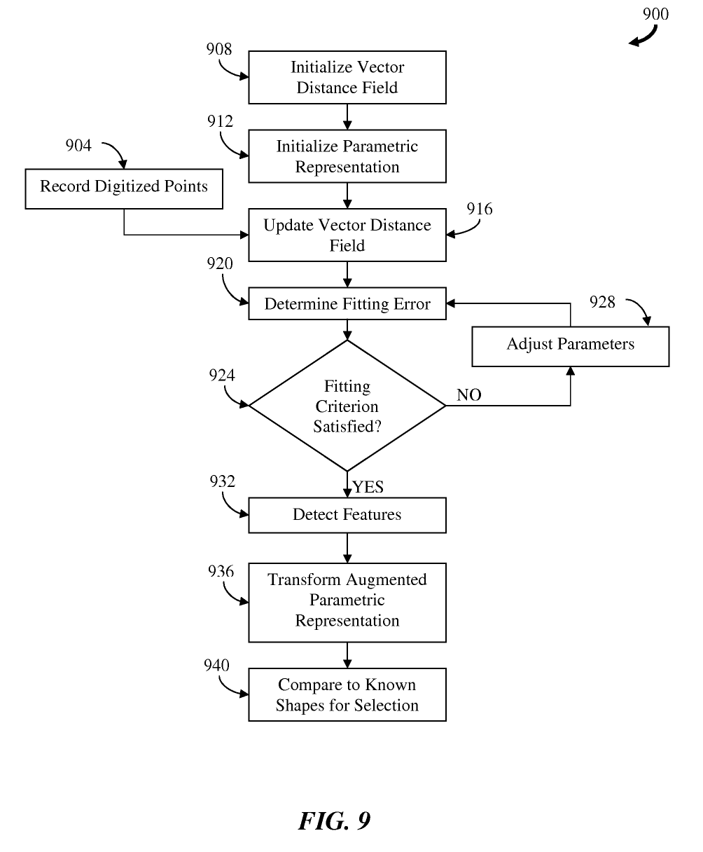

FIG. 9 illustrates the method 900 according to the fifth embodiment. A digitizing device records 904 a set of digitized points along an input path representing an intended shape such as a particular character glyph. A vector distance field representing the input path is initialized 908 and a parametric representation of the set of digitized points is initialized 912. As each new digitized point is recorded by the digitizing device, the vector distance field is updated 916.

A fitting error is determined 920 from the vector distance field and the parametric representation. Parameters of the parametric representation are iteratively adjusted 928 to reduce the fitting error if it is determined 924 that a fitting criterion is not satisfied. Various fitting criteria can be applied. For example, the parameter adjustment can be terminated when the fitting error is less than a specified threshold, when a maximum number of iterations have been performed, or when a user stops the fitting adjustment.

Features such as corners in the input path, positions of high curvature, time intervals along the input path, as well as positions and timings of pen-down and pen-up events are detected 932 and associated with the parametric representation to form an augmented parametric representation. The augmented parametric representation is then transformed 936, for example by scaling and offsetting, to form a transformed parametric representation. Finally, the transformed parametric representation is compared 940 to the transformed parametric representations of a set of known shapes and a closest shape in the set is selected to be the recognized shape.

Although the invention has been described by way of preferred embodiments, it is to be understood that various other applications and modifications can be made within the spirit and scope of the invention. Therefore, it is the object of the appended claims to cover all such variations and modifications as come within the true spirit and scope of the invention.

1. A method for fitting a parametric representation to a set of objects, comprising:
generating a vector distance field representation of the set of objects;
initializing a parametric representation to fit the set of objects;
determining a fitting error from the vector distance field representation, the fitting error indicating an accuracy of the fit of the parametric representation to the set of objects; and
adjusting the parametric representation to reduce the fitting error.

2. The method of claim 1 wherein the parametric representation comprises a parametric curve.

3. The method of claim 2 wherein the parametric curve comprises one of a line segment, a quadratic Bezier curve, a cubic Bezier curve and an nth order polynomial curve.

4. The method of claim 1 wherein the parametric representation comprises a parametric surface patch.

5. The method of claim 4 wherein the parametric surface patch comprises one of a triangle, a polygon, a Bezier patch, a NURBs patch and an nth order curved parametric patch.

6. The method of claim 1 wherein the parametric representation comprises an n-dimensional parametric shape.

7. The method of claim 6 wherein the n-dimensional parametric shape comprises one of a circle, an ellipse, a rectangular region, a sphere, a rectilinear solid, an ellipsoid, a super-ellipsoid and an n-dimensional solid.

8. The method of claim 1 wherein the parametric representation approximates a path corresponding to the set of objects.

9. The method of claim 1 wherein the parametric representation approximates a boundary corresponding to the set of objects.

10. The method of claim 1 wherein the parametric representation approximates a two-dimensional region corresponding to the set of objects.

11. The method of claim 1 wherein the parametric representation approximates a surface corresponding to the set of objects.

12. The method of claim 1 wherein the parametric representation approximates a volume corresponding to the set of objects.

13. The method of claim 1 wherein the parametric representation approximates an n-dimensional solid corresponding to the set of objects.

14. The method of claim 1 wherein the parametric representation approximates a medial axis corresponding to the set of objects.

15. The method of claim 1 wherein the parametric representation approximates a medial surface corresponding to the set of objects.

16. The method of claim 1 wherein the set of objects comprises one of a set of points, a set of line segments and a set of curves.

17. The method of claim 1 wherein the set of objects comprises a boundary representation.

18. The method of claim 17 wherein the boundary representation comprises one of a set of triangles, a set of quadrilaterals, a set of parametric patches, a set of Bezier patches and a set of NURBs patches.

19. The method of claim 1 wherein an object in the set of objects is represented by an implicit function.

20. The method of claim 1 wherein an object in the set of objects is represented by an analytic function.

21. The method of claim 1 wherein an object in the set of objects is represented by sampled data.

22. The method of claim 21 wherein the sampled data is represented as one of an image, a sampled volume and an adaptively sampled distance field.

23. The method of claim 1 wherein the vector distance field representation is an analytic function.

24. The method of claim 1 wherein the vector distance field representation is a procedure.

25. The method of claim 1 wherein the vector distance field representation is a regularly sampled vector distance field.

26. The method of claim 1 wherein the vector distance field representation is an adaptively sampled vector distance field.

27. The method of claim 1 wherein the vector distance field representation comprises a scalar distance field representation, the method further comprising determining a vector distance from the scalar distance field representation.

28. The method of claim 27 wherein the determining a vector distance from the scalar distance field representation comprises determining the vector distance from a derivative of the scalar distance field representation.

29. The method of claim 28 wherein the derivative is determined using an analytic function.

30. The method of claim 28 wherein the derivative is determined using a procedure.

31. The method of claim 28 wherein the scalar distance field representation is a sampled distance field and the derivative is determined using a gradient operator.

32. The method of claim 31 wherein the gradient operator is a central differences operator.

33. The method of claim 1 wherein the fitting error is a function of a set of measurements between the parametric representation and the set of objects.

34. The method of claim 33 wherein the set of measurements comprises one of a set of signed scalar distances, a set of unsigned scalar distances and a set of squared scalar distances.

35. The method of claim 33 wherein the set of measurements comprises a set of partial derivatives of the vector distance field.

36. The method of claim 33 wherein the measurements are determined from the vector distance field representation.

37. The method of claim 33 wherein the function samples the measurements at a set of points on the parametric representation.

38. The method of claim 33 wherein the function samples the measurements at a set of points near the parametric representation.

39. The method of claim 33 wherein the function samples the measurements at a set of points offset from the parametric representation.

40. The method of claim 1 wherein the adjusting comprises changing a set of parameters in the parametric representation.

41. The method of claim 40 wherein adjusting a parameter in the set of parameters comprises changing the parameter by a function of the derivative of the fitting error with respect to the parameter.

42. The method of claim 40 wherein adjusting a parameter in the set of parameters constrains the parameter according to at least one constraint.

43. The method of claim 42 wherein the at least one constraint comprises a geometric constraint.

44. The method of claim 43 wherein the geometric constraint is one of a point, a line, a curve and a surface.

45. The method of claim 42 wherein the at least one constraint comprises one of a function of a normal vector of the parametric representation, a function of a tangent vector of the parametric representation and a function of a curvature of the parametric representation.

46. The method of claim 1 wherein the determining and the adjusting are repeated until terminated by a user.

47. The method of claim 1 wherein the adjusting is iterated to reduce the fitting error.

48. The method of claim 47 wherein the adjusting is terminated when a maximum number of iterations have been performed.

49. A computer program product for fitting a parametric representation to a set of objects, the computer program product comprising a computer useable medium having embodied therein program code comprising:
program code for generating a vector distance field representation of the set of objects;
program code for initializing a parametric representation to fit the set of objects;
program code for determining a fitting error from the vector distance field representation, the fitting error indicating an accuracy of the fit of the parametric representation to the set of objects; and
program code for adjusting the parametric representation to reduce the fitting error.

50. An apparatus for fitting a parametric representation to a set of objects, comprising:
means for generating a vector distance field representation of the set of objects;
means for initializing a parametric representation to fit the set of objects;
means for determining a fitting error from the vector distance field representation, the fitting error indicating an accuracy of the fit of the parametric representation to the set of objects; and
means for adjusting the parametric representation to reduce the fitting error.
